(19) United States
(12) Patent Application Publication
(10) Pub. No.: US 2004/0120731 A1
(43) Pub. Date: Jun. 24, 2004

(54) Developing device and image forming apparatus

(75) Inventors: Junji Machida, Osaka (JP); Hiroshi Goto, Kawanishi-shi (JP)

Correspondence Address: Barry E. Bretschneider, Morrison & Foerster LLP, Suite 300, 1650 Tysons Boulevard, McLean, VA, 22102, US

(73) Assignee: Minolta Company, Ltd., Osaka (JP)

(21) Appl. No.: 10/734,143

(22) Filed: Dec. 15, 2003

Related U.S. Application Data
(62) Division of application No. 09/924,494, filed on Aug. 9, 2001.

(30) Foreign Application Priority Data
Aug. 10, 2000 (JP) 2000-242007

(51) Int. Cl. G03G 15/02

(52) U.S. Cl. 399/176

(57) ABSTRACT

A developing device according to the present invention includes a developer carrying member, a storage portion for storing a toner to be supplied to the developer carrying member, and a regulating member disposed in contacting relation with a surface of the developer carrying member for regulating the amount of toner carried on the developer carrying member, the surface of the developer carrying member having a rubber hardness of 20 to 70 degrees, an elongation of 400 to 1200% and a volume electrical resistance of 1×10⁴ to 1×10⁹ Ω.cm, the toner containing an organic aromatic solvent and a vinyl monomer in combined concentrations of not more than 500 ppm.

This application is based application No. 242007/2000 filed in Japan, the contents of which are hereby incorporated by reference.

### BACKGROUND OF THE INVENTION

1. Field of the Invention

The present invention relates to an image forming apparatus, such as copiers, printers and the like, and to a developing device assembled in such an image forming apparatus for developing an electrostatic latent image, formed on an image bearing member, by using a developer. More particularly, the invention is directed to the prohibition against any deterioration of the characteristics of a developer carrying member, regulating member, supply roller and charger member due to contact with the developer, the developer carrying member operating to transport the developer to a development region opposite the image bearing member, the regulating member operating to regulate the amount of developer carried on the developer carrying member to the development region, the supply roller serving to supply the developer to the developer carrying member, the charger member allowed to contact a surface of the image bearing member for electrifying the surface thereof.

2. Description of the Related Art

The image forming apparatuses, such as copiers, printer and the like, have conventionally employed various types of developing devices for developing the electrostatic latent image formed on the image bearing member.

There have been known a developing device of the two-component development system employing a developer comprising a carrier and a toner, as well as a developing device of the one-component system employing a developer comprising a toner alone but no carrier.

A typical image forming apparatus employing the developing device of the one-component system is shown in FIG. 1.

Such an image forming apparatus operates as follows. A surface of a rotating image bearing member 1 is electrified at a predetermined potential by means of a charger device 2 of the corona discharge system. Subsequently, an electrostatic latent image forming device 3 forms an electrostatic latent image on the surface of the image bearing member 1 by irradiating the surface of the image bearing member 1 with laser light or the like corresponding to image information. Then, a developing device 10 supplies a toner t to an area of the electrostatic latent image thus formed, thereby forming a toner image on the surface of the image bearing member 1. The toner image is transferred from the image bearing member 1 to a receiving medium 5, such as paper, by means of a transfer device 4.

The developing device 10 supplies the toner t to the electrostatic latent image formed on the surface of the image bearing member 1 in the following manner. A developer carrying member 11 is disposed in opposing relation with the image bearing member 1. While the developer carrying member 11 is rotated, the toner t stored in the developing device 10 is fed to a supply roller 13 by means of a feeding member 12, the supply roller 13 rotating in contacting relation with the developer carrying member 11. Thus, the toner t is supplied to the developer carrying member 11.

The toner t thus supplied to the surface of the developer carrying member 11 is carried on the developer carrying member 11. On the other hand, a regulating member 14 is pressed against the surface of the developer carrying member 11 for concurrently regulating the amount of toner t carried on the surface of the developer carrying member 11 and triboelectrifying the toner t. The toner thus regulated and triboelectrified by the regulating member 14 is introduced in a development region opposite the image bearing member 1 by means of the developer carrying member 11. At the same time, a developing bias voltage from a power source 15 is applied to the developer carrying member 11 such that the toner t carried on the surface of the developer carrying member 11 may be supplied to an area of the electrostatic latent image formed on the image bearing member 1.

In the above developing device 10, it has been a general practice to provide countermeasures against toner cracks and the like by forming an elastic layer on the surface of the developer carrying member 11 or forming a portion of the regulating member 14 from an elastic material, the portion contacting the developer carrying member 11. The toner cracks are produced when the regulating member 14 is pressed against the surface of the developer carrying member 11 for regulating the amount of toner t carried on the surface thereof.

The above developing device 10 normally employs a supply roller 13 formed from an elastic foam material such that the supply roller 13 may properly supply the toner t to the developer carrying member 11.

In the toner t generally used in the art, there still remain an organic aromatic solvent and a vinyl monomer which were used in the process for preparing the toner t. Where such a toner t is used in the above developing device 10, the organic aromatic solvent and vinyl monomer remaining in the toner t will gradually penetrate into the elastic layer on the surface of the developer carrying member 11 or into the regulating member 14 and the supply roller 13, causing progressive deterioration of the characteristics of these members. As a result, produced images are adversely affected.

In the case of the above image forming apparatus wherein the surface of the image bearing member 1 is electrified by means of the charger device 2 of the corona discharge system, the application of high voltage is required for effecting the corona discharge while on the other hand, destructive substances, such as ozone, are produced during the corona discharge.

In this connection, more recent years have seen the adoption of a developing device wherein a charger member (not shown) is allowed to contact the surface of the image bearing member 1 for electrifying the same.

As the charger member allowed to contact the surface of the image bearing member 1 for electrifying the same, there has been employed one formed from an elastic material such that the surface of the image bearing member 1 may be uniformly electrified.

In the case of the charger member formed from the elastic material, however, the toner t remaining on the surface of the image bearing member 1 is in contact with the charger member. Therefore, the organic aromatic solvent and vinyl monomer remaining in the toner t gradually penetrate into the charger member to cause progressive deterioration of the characteristics thereof, which, in turn, adversely affects images so produced.

### SUMMARY OF THE INVENTION

It is an object of the invention to provide a developing device adapted to prevent the developer carrying member from suffering the deteriorated characteristics thereof due to contact with the toner, thereby to provide preferable images in a stable manner.

It is another object of the invention to provide a developing device adapted to prevent the regulating member from suffering the deteriorated characteristics thereof due to contact with the toner, thereby to provide preferable images in a stable manner, the regulating member operating to regulate the amount of toner carried on the developer carrying member.

It is still another object of the invention to provide a developing device adapted to prevent the supply roller from suffering the deteriorated characteristics thereof due to contact with the toner, thereby to provide preferable images in a stable manner, the supply roller operating to supply the toner to the developer carrying member.

It is yet another object of the invention to provide a developing device adapted to prevent the contact-charger member from suffering the deteriorated characteristics thereof due to contact with the toner, thereby to provide preferable images in a stable manner, the charger member operating to electrify the image bearing member.

According to a first aspect of the invention, a developing device comprises: a developer carrying member having a rubber hardness of 20 to 70 degrees, an elongation of 400 to 1200% and a volume electrical resistance of 1×10⁴ to 1×10⁹ Ω.cm at its surface; a storage portion for storing a toner to be supplied to the developer carrying member, the toner containing an organic aromatic solvent and a vinyl monomer in combined concentrations of not more than 500 ppm; and a regulating member disposed in contacting relation with the surface of the developer carrying member for regulating the amount of toner carried on the developer carrying member.

According to a second aspect of the invention, a developing device comprises: a developer carrying member for carrying a toner on its surface; a storage portion for storing the toner to be supplied to the developer carrying member, the toner containing an organic aromatic solvent and a vinyl monomer in combined concentrations of not more than 500 ppm; and a regulating member disposed in contacting relation with the surface of the developer carrying member for regulating the amount of toner carried on the developer carrying member, and having a rubber hardness of 20 to 70 degrees and an elongation of 100 to 800%.

According to a third aspect of the invention, a developing device comprises: a developer carrying member for carrying a toner on its surface; a storage portion for storing the toner containing an organic aromatic solvent and a vinyl monomer in combined concentrations of not more than 500 ppm; a supply roller for supplying the developer carrying member with the toner stored in the storage portion, the supply roller including an elastic-foam layer having an Asca F hardness of 30 to 80 degrees and a cell count of 2 to 10 cells/mm; and a regulating member disposed in contacting relation with the surface of the developer carrying member for regulating the amount of toner carried on the developer carrying member.

According to the invention, an image forming apparatus comprises: an image bearing member; a charger member disposed in contacting relation with the image bearing member, and having a rubber hardness of 40 to 90 degrees and a volume electrical resistance of 1×10⁴ to 1×10¹⁰ Ω.cm at its portion contacting the image bearing member; a developing device including a developer carrying member for carrying a toner on its surface, a storage portion for storing the toner containing an organic aromatic solvent and a vinyl monomer in combined concentrations of not more than 500 ppm, and a regulating member disposed in contacting relation with the surface of the developer carrying member for regulating the amount of toner carried on the developer carrying member, the developing device operating to form a toner image on the image bearing member; and a transfer member for transferring the toner image thus formed on the image bearing member onto a receiving medium.

These and other objects, advantages and features of the invention will become apparent from the following description thereof taken in conjunction with the accompanying drawings which illustrate specific embodiments of the invention.

### BRIEF DESCRIPTION OF THE DRAWINGS

FIG. 1 is a schematic diagram illustrating a conventional image forming apparatus;

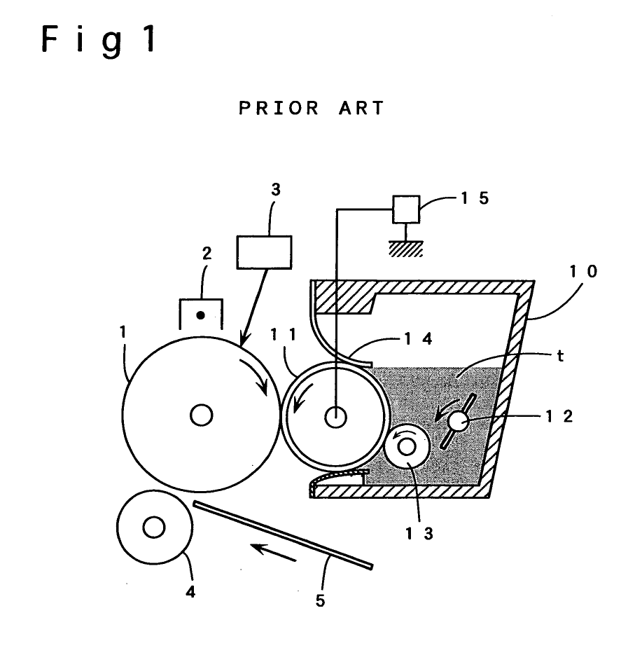

FIG. 2 is a schematic diagram showing an arrangement of an image forming apparatus according to a first embodiment of the invention;

FIG. 3 is a schematic diagram showing an arrangement of a developing device according to a second embodiment of the invention;

FIG. 4 is a schematic diagram showing an arrangement of a developing device according to a third embodiment of the invention;

FIG. 5 is a schematic diagram showing an arrangement of a developing device according to a fourth embodiment of the invention; and

FIG. 6 is a schematic diagram showing an arrangement of a modification of the image forming apparatus according to the first embodiment of the invention.

### DESCRIPTION OF THE PREFERRED EMBODIMENTS

A developing device and an image forming apparatus according to preferred embodiments of the invention will hereinbelow be described in detail with reference to the accompanying drawings.

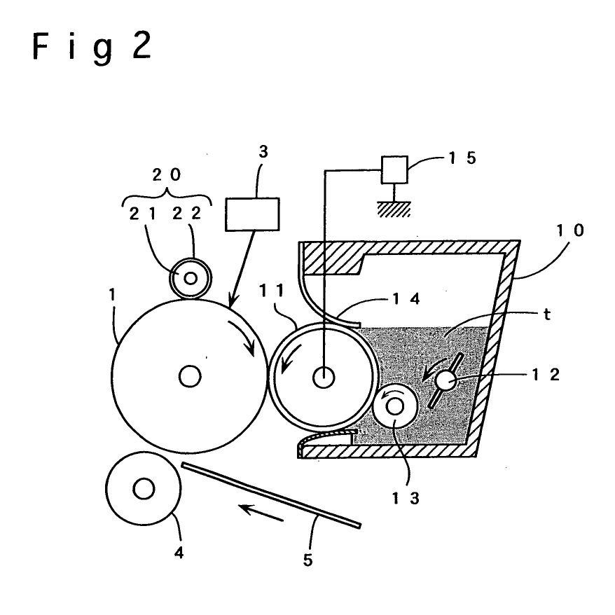

In an image forming apparatus according to a first embodiment of the invention, an electrostatic latent image is formed on a surface of an image bearing member 1 as follows. As shown in FIG. 2, a roller-like charger member 20 is allowed to contact the surface of the rotating image bearing member 1 thereby electrifying the surface of the image bearing member 1 at a predetermined potential. Subsequently, an electrostatic latent image forming device 3 based on laser or the like irradiates the surface of the image bearing member 1 with light corresponding to image information thereby forming the electrostatic latent image on the surface of the image bearing member.

Then, a developing device 10 supplies a toner t to an area of the resultant electrostatic latent image for forming a toner image on the surface of the image beating member 1. Then, a transfer device 4 transfers the toner image from the image bearing member 1 onto a receiving medium 5 such as paper.

Likewise to the conventional arrangement, a developer carrying member 11 opposes the image bearing member 1 in contacting relation therewith so as to supply the toner t from the developing device 10 to the latent image formed on the surface of the image bearing member 1. While the developer carrying member is rotated, a feeding member 12 feeds the toner t stored in the developing device 10 to a supply roller 13 rotating in contacting relation with the developer carrying member 11, so that the toner t is supplied to the developer carrying member 11 via the supply roller 13.

The toner t thus supplied to the surface of the developer carrying member 11 is carried on the developer carrying member 11, while a regulating member 14 is pressed against the surface of the developer carrying member 11 for regulating the amount of toner t carried on the retentive surface of the developer carrying member 11 as well as for triboelectrifying the toner t so carried. While the toner t thus regulated and triboelectrified by the regulating member 14 is introduced in a development region opposite the image bearing member 1 by means of the developer carrying member 11, a developing bias voltage from a power source 15 is applied to the developer carrying member 11 thereby selectively supplying the toner t from the retentive surface of the developer carrying member 11 to an area of the electrostatic latent image formed on the image bearing member 1.

The image forming apparatus of this embodiment employs the toner t which contains an organic aromatic solvent and a vinyl monomer in combined concentrations of not more than 500 ppm, preferably of not more than 300 ppm, or more preferably of not more than 200 ppm.

The above toner t comprises a binder resin to which a coloring agent, charge control agent and/or lubricant are added. If required, a fluidizer may be added to the toner.

The above binder resin may be any of the known binder resins conventionally used in the art. Examples of a usable binder resin include polyesters, styrenes, styrene-acryl resins, styrene-butadiene resins, epoxy resins, synthetic rosin esters and the like. These binder resins may be used alone or in combination of two or more types.

The binder resin may have a number average molecular weight Mn in the range of 1000 to 20000 or preferably of 2000 to 15000, and a ratio between a weight average molecular weight Mw and the number average molecular weight Mn (Mw/Mn) in the range of 2 to 80 or preferably of 3 to 70 as determined by gel-permeation chromatography (830-R1 commercially available from JASCO Corporation); a softening point Tm in the range of 80° C. to 150° C. or preferably of 90° C. to 140° C. as determined by flow tester (CFT-500D commercially available from Shimadzu Corporation); and a glass transition point Tg in the range of 50° C. to 75° C. or preferably of 58° C. to 70° C. as determined by differential scanning calorimeter (DSC-200 commercially available from Seiko Instruments Inc.).

The binder resin having the number average molecular weight Mn in the range of 1000 to 20000 and the softening point Tm in the range of 80° C. to 150° C. is employed herein for the following reasons. If the binder resin has a number average molecular weight Mn of below 1000 and a softening point Tm of below 80° C., the resultant toner is so fragile to suffer a poor durability. If, on the other hand, the number average molecular weight Mn exceeds 20000 and the softening point Tm is above 150° C., the resultant toner t is decreased in the adhesion to the receiving medium 5 such as paper.

The binder resin having the glass transition point Tg in the range of 50° C. to 75° C. is employed herein for the following reasons. If the binder resin has a glass transition point Tg of less than 55° C., the resultant toner is decreased in the heat resistance and prone to produce particle aggregation. If, on the other hand, the glass transition point Tg exceeds 75° C., the resultant toner t suffers a lower adhesion to the receiving medium 5 such as paper.

The above toner t may employ any of the known coloring agents conventionally used in the art. Examples of a usable coloring agent include carbon black, aniline black, magnetite, Benzine Yellow, Permanent Yellow, Naphthol Yellow, Phthalocyanine Blue, Fast Sky Blue, Ultra Marine Blue, Rose Bengal, Lake Red, quinacridone and the like. A preferred mixing ratio of the coloring agent is normally in the range of 2 to 20 parts by weight based on 100 parts by weight of binder resin.

The above toner t may employ any of the known charge control agents conventionally used in the art. Examples of a usable negative-charge control agent include organic metal complexes, chelate compounds, metal complexes of monoazo, metal complexes of aromatic hydroxycarboxylic acid, metal complexes of aromatic dicarboxylic acid and the like. Examples of a usable positive-charge control agent include nigrosine dyes, triphenylmethane dyes, Kalex Allene compounds, quaternary ammonium salt compounds, imidazole compounds and the like. A mixing ratio of the charge control agent is normally in the range of 1 to 10 parts by weight or preferably of 2 to 8 parts by weight based on 100 parts by weight of binder resin.

The above toner t may employ any of the known lubricants conventionally used in the art. Examples of a usable lubricant include low-molecular-weight polyethylene, low-molecular-weight polypropylene, oxidized low-molecular-weight polyethylene, oxidized low-molecular-weight polypropylene, microcrystalline wax, paraffin wax, Carnauba Wax, Saxol Wax, rice wax, jojoba wax and the like. These lubricants may be used alone or in combination of two or more types. A mixing ratio of the lubricant is normally in the range of 1 to 30 parts by weight or preferably of 2 to 25 parts by weight based on 100 parts by weight of binder resin.

The above toner t may employ any of the known fluidizers conventionally used in the art. Examples of a usable fluidizer include inorganic fine particles such as of colloidal silica, titanium oxide, aluminum oxide, strontium titanate and the like; and fine resin particles 0.1 to 1 μm in size, such as of acrylic resins, styrene resins, styrene-acryl resins, silicone resins, fluororesins and the like. Particularly preferred are the above inorganic fine particles hydrophobic-treated with a silane coupling agent, titanium coupling agent, silicone oil or the like. A mixing ratio of the fluidizer is in the range of 0.1 to 2 parts by weight or preferably of 0.2 to 1.5 parts by weight based on 100 parts by weight of toner.

The above toner may be prepared by any of the known methods conventionally used in the art, which include, for example, milling, emulsion-polymerization, suspension-polymerization, spray drying and the like.

If the toner t is too small in particle size, the toner t suffers a poor fluidity and a cleaning failure may result. If, on the other hand, the toner is too great in particle size, the reproducibility of halftone images is lowered. Therefore, the toner having a volume average particle size of 5 to 14 μm may be used. If the toner t contains an excessive amount of toner particles not more than 3 μm in size, such toner particles t may be fused to the developer carrying member 11 and the regulating member 14 so that the toner t is not uniformly electrified. This results in the production of fogged images or images of non-uniform density. Hence, it is preferred to employ a toner t in which the toner particles 3 μm or less in size are present in concentrations of not more than 20% in terms of the percentage of particle count.

In order to obtain a toner t in which the organic aromatic solvent and vinyl monomer remain in combined concentrations of not more than 500 ppm, a vacuum drying or heating may be performed in the process for preparing the binder resin. Otherwise, the heating may be performed in the process for preparing the toner t.

This embodiment employs the charger member 20 which comprises a metallic roller 21 and a surface layer 22 of an elastic material laid over an outer periphery of the roller. The surface layer has a rubber hardness of 40 to 90 degrees, preferably of 50 to 80 degrees or more preferably of 60 to 80 degrees, and a volume electrical resistance of 1×10⁴ to 1×10¹⁰ Ω.cm, preferably of 1×10⁵ to 1×10⁹ Ω.cm, or more preferably of 5×10⁵ to 5×10⁸ Ω.cm. It is noted that the above rubber hardness is determined according to JIS K 6301.

The surface of the image bearing member 1 may be uniformly charged by employing the charger member 20 with the surface layer 22 having the rubber hardness of 40 to 90 degrees and the volume electrical resistance of 1×10⁴ to 1×10¹⁰ Ω.cm, the charger member 20 allowed to contact the surface of the image bearing member 22 in conformity therewith.

Furthermore, the embodiment employs the toner containing the organic aromatic solvent and vinyl monomer in the combined concentrations of not more than 500 ppm and therefore, the surface layer 22 of the charger member 20 suffers less penetration of the organic aromatic solvent and vinyl monomer contained in the toner. Thus is prevented the change of the characteristics, such as rubber hardness and electrical resistance, of the surface layer 22 and hence, the surface of the image bearing member 1 is uniformly charged in a stable manner. This ensures that favorable images are provided over an extended period of time.

Examples of the elastic material suitable for the charger member 20 include a variety of rubbers and thermoplastic elastomers such as a styrene-butadiene system, an ethylene-propylene-butadiene system, a polyurethane system, a polybutadiene system, a polyester system, a polyvinyl chloride system, a polyamide system, an acrylonitrile-butadiene system, a hydrogenated acrylonitrile-butadiene system, natural rubbers, cis-polyisoprene, styrene-butadiene rubbers, cis-polybutadiene, chloroprene rubbers, butyl rubbers, nitrile rubbers, ethylene-propylene rubbers, acrylic rubbers, urethane rubbers, silicone rubbers and the like. These materials may be used alone or in combination of two or more types. These elastic materials may be added with a vulcanizing agent such as sulfur and the like; a vulcanization accelerator such as guanidine, thiazole, sulfenamide, dithiocarbamate and the like; or a softener such as stearic acid, zinc white and the like.

It is also possible to form the surface layer 22 which includes the elastic layer formed from any of the above elastic materials, and a coat layer such as formed from, for example, a polyurethane resin, acrylic resin, phenol resin, silicone resin, polycarbonate resin, butadiene rubber, nitrile rubber, acrylic rubber or the like and laid over the elastic layer.

Furthermore, the above elastic material may be admixed with an electroconductivity imparting agent in order to control the volume electrical resistance of the surface layer 22 of the charger member 20 in the range of 1×10⁴ to 1×10 Ω.cm.

Examples of a usable electroconductivity imparting agent include fine particles such as of ketchen black, acetylene black, furnace black, graphite, metal oxides and the like; surfactants; ionic electroconductive materials such as quaternary ammonium salt, boric acid, and the like.

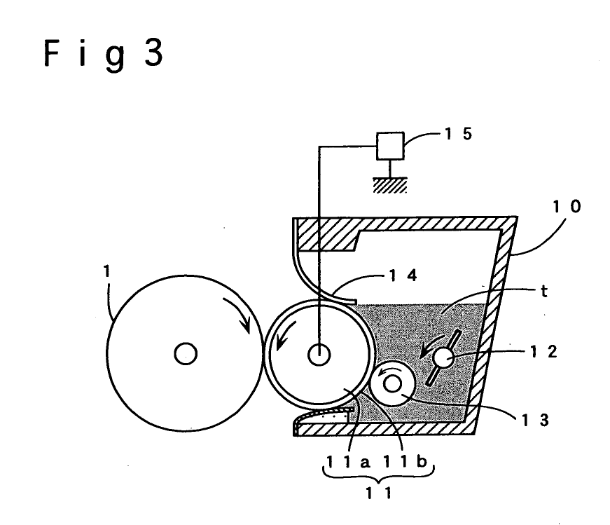

In a second embodiment of the invention, a developing device employs a developer carrying member 11 which comprises a metallic roller 11a and a surface layer 11b formed from an elastic material and laid over an outer periphery of the roller, as shown in FIG. 3. The surface layer 11b has a rubber hardness of 20 to 70 degrees, preferably of 30 to 65 degrees, or more preferably of 40 to 60 degrees; an elongation of 400 to 1200%, preferably of 450 to 1000%, or more preferably of 450 to 800%; and a volume electrical resistance of 1×10⁴ to 1×10⁹ Ω.cm, preferably of 5×10⁴ to 1×10⁸ Ω.cm, or more preferably of 1×10⁵ to 1×10⁷ Ω.cm. It is noted that the above rubber hardness and elongation are determined according to JIS K 6301.

The following merit is provided by using the developer carrying member 11, the surface layer 11b of which has the rubber hardness of 20 to 70 degrees, the elongation of 400 to 1200% and the volume electrical resistance of 1×10⁴ to 1×10⁹ Ω.cm. That is, when the regulating member 14 is allowed to contact the developer carrying member 11 for regulating the amount of toner to be transported to the development region, the toner is prevented from cracking and can be suitably electrified.

Since the toner containing the organic aromatic solvent and vinyl monomer in the combined concentrations of not more than 500 ppm is used, the surface layer 11b of the developer carrying member 11 suffers less penetration of the organic aromatic solvent and vinyl monomer contained in the toner. Thus is prevented the change in the characteristics, such as rubber hardness and elongation, of the surface layer 11b. This ensures that favorable images are provided over an extended period of time.

The same elastic material for the charger member 20 may be used for forming the surface layer 11b over the outer periphery of the metallic roller 11a. Similarly to the above charger member 20, the surface layer 22 may include the elastic layer formed from such an elastic material and the coat layer laid over the surface thereof. In addition, the elastic material may be admixed with the same electroconductivity imparting agent as used for the charger member 20, such that the surface layer 11b may have a suitable electrical resistance.

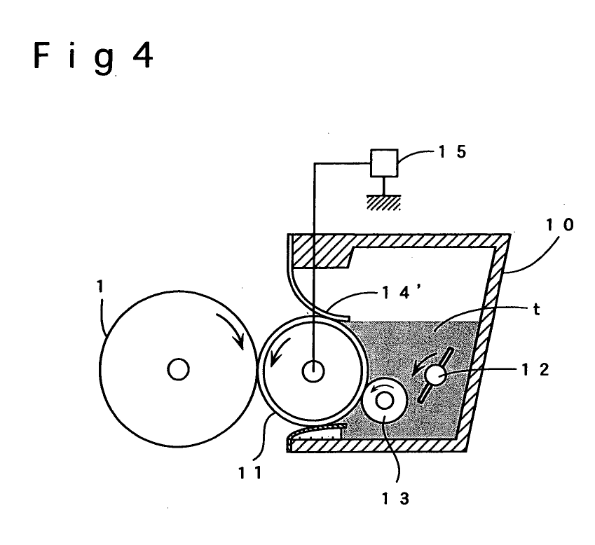

In a third embodiment of the invention, a developing device employs a regulating member 14′ formed from an elastic material, as shown in FIG. 4. The regulating member has a rubber hardness of 20 to 70 degrees, preferably of 30 to 65 degrees or more preferably of 40 to 60 degrees; and an elongation of 100 to 800%, preferably of 200 to 700% or more preferably of 300 to 650%. It is noted that the above rubber hardness and elongation are determined according to JIS K 6301.

By using the regulating member 14′ having the rubber hardness of 20 to 70 degrees and the elongation of 100 to 800%, it is ensured that the toner cracks are prevented when the regulating member 14′ is allowed to contact the surface of the developer carrying member 11 for regulating the amount of toner to be transported to the development region.

Since the toner containing an organic aromatic solvent and a vinyl monomer in the combined concentrations of not more than 500 ppm is used, the regulating member 14′ suffers less penetration of the organic aromatic solvent and vinyl monomer contained in the toner. Thus is prevented the change in the characteristics, such as rubber hardness and elongation, of the regulating member 14′. This ensures that favorable images are provided over an extended period of time.

The same elastic material as in the foregoing charger member 20 may be used for the regulating member 14′. Similarly to the charger member 20, the coat layer may be laid over a surface of the base material constituting the regulating member 14′. It is also possible to admix the elastic material with the same electroconductivity imparting agent as in the charger member 20 such that the regulating member 14′ may present a suitable electrical resistance. In the regulating member 14′, the intrinsic volume resistance thereof may be controlled in the range of 1×10² to 1×10 Ω.cm, or preferably of 1×10³ to 1×10 Ω.cm.

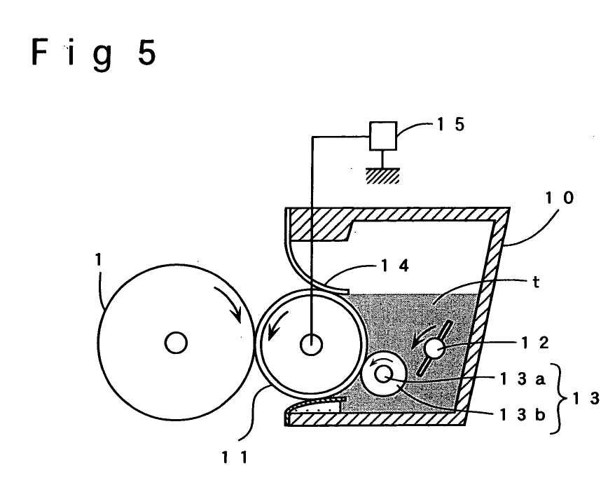

In a fifth embodiment of the invention, a developing device employs a supply roller 13 which comprises a metallic roller 13a and an elastic-foam layer 13b laid over an outer periphery of the roller, as shown in FIG. 5. The elastic-foam layer 13b has an Asca F hardness of 30 to 80 degrees, preferably of 35 to 75 degrees, or more preferably of 40 to 70 degrees; and a cell count of 2 to 10 cells/mm, preferably of 3 to 9 cells/mm, or more preferably of 4 to 8 cells/mm.

If the toner is supplied to the developer carrying member 11 by means of the supply roller 13 with the elastic-foam layer 13b having the Asca F hardness of 30 to 80 degrees and the cell count of 2 to 10 cells/mm, a proper amount of toner may be supplied to the developer carrying member without suffering cracks.

Since the toner containing an organic aromatic solvent and a vinyl monomer in the combined concentrations of not more than 500 ppm is used, the supply roller 13 suffers less penetration of the organic aromatic solvent and vinyl monomer contained in the toner. Thus is prevented the change in the characteristics, such as Asca F hardness, of the supply roller 13. This ensures that favorable images are provided over an extended period of time.

In the supply roller 13, the same elastic material as in the charger member 20 may be used for the elastic-foam layer 13b. A foaming agent may be used in combination with such an elastic material, thereby producing a foam. Similarly to the charger member 20, the coat layer may be laid over a surface of the elastic-foam layer 13b. Furthermore, it is also possible to admix the elastic material with the same electroconductivity imparting agent as in the charger member 20 such that the elastic-foam layer 13b of the supply roller 13 may present a suitable electrical resistance. In the supply roller 13, the intrinsic volume resistance of the elastic-foam layer 13b may be controlled in the range of not more than 1×10¹⁰ Ω.cm, or preferably of 1×10² to 1×10⁹ Ω.cm.

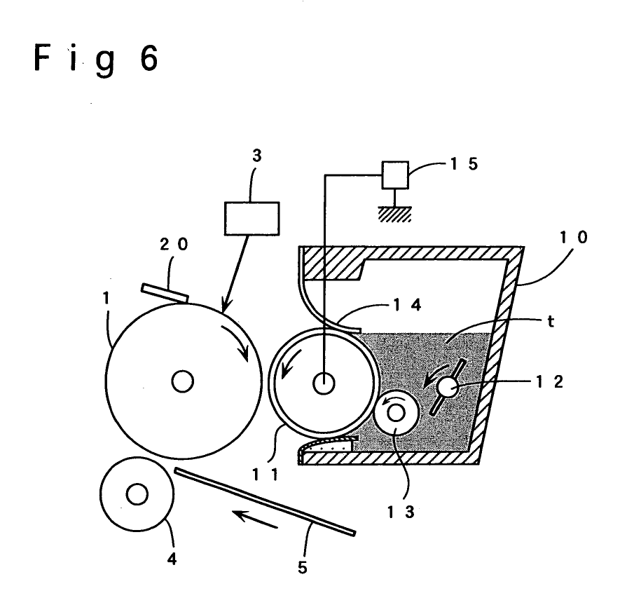

In the first embodiment of the invention, the image forming apparatus employs the charger member 20 comprising the metallic roller 21 and the surface layer 22 of the elastic material which is laid over the outer periphery of the metallic roller. However, an alternative arrangement may be made wherein the charger member 20 in the form of a sheet is allowed to contact the surface of the rotating image bearing member 1, as shown in FIG. 6.

In the image forming apparatus of the first embodiment and the developing devices of the second to the fourth embodiments hereof, the developer carrying member 11 for supplying the toner t to the image bearing member 1 is disposed in contacting relation with the image bearing member 1 in order to supply the toner t from the developing device 10 to the latent image formed on the surface of the image bearing member 1. An alternative arrangement may be made, as shown in FIG. 6, wherein the developer carrying member 11 opposes the image bearing member 1 via a predetermined gap therebetween while the toner t is caused to jump from the developer carrying member 11 so as to be supplied to the image bearing member 1.

The following tests were conducted with modifications made to the toner t to be used, the charger member 20, the elastic layer 11b of the developer carrying member 11, the regulating member 14 and the supply roller 13 in order to demonstrate that favorable images are obtained in a stable manner if the conditions of the invention are satisfied.

The following test used six types of toners t1 to t6 which were prepared as follows.

(Toner t1)

Toner t1 was prepared as follows. A reaction vessel equipped with a reflux condenser, mechanical stirrer and thermometer was charged with 200 parts by weight of toluene, 85 parts by weight of styrene monomer, and 15 parts by weight of n-butyl acrylate monomer along with lauryl peroxide as a polymerization initiator. The mixture was reacted at 60° C. for 4 hours, and then at 80° C. for 2 hours. Subsequently, styrene-acryl copolymer was obtained by removing the solvent of toluene in vacuo.

Next, 45 parts by weight of styrene-acryl copolymer thus obtained was dissolved in 200 parts by weight of toluene. The resultant solution mixture was heated to a boiling point of toluene in the reaction vessel with the reflux condenser, mechanical stirrer and thermometer. With toluene refluxed, a mixture containing 45 parts by weight of styrene monomer, 10 parts by weight of n-butyl acrylate monomer, and 5 parts by weight of benzoyl peroxide as a polymerization initiator was added while stirring. The resultant mixture was polymerized over the course of 3 hours. Subsequently, the mixture was cooled to room temperatures and then added with 100 parts by weight of acetone. Then, the toluene and acetone as the solvent were removed in vacuo.

Subsequently, the resultant styrene-acryl copolymer was added to 200 parts by weight of methanol and stirred at room temperatures for 30 minutes. The methanol was removed in vacuo. The resin was subjected to 24-hour vacuum drying at 40° C. thereby to give styrene-acryl copolymer to be used as the binder resin.

The styrene-acryl copolymer had a glass transition point Tg of 58.9° C., a number average molecular weight Mn of 5900, and a softening point Tm of 123° C.

There was prepared a mixture of 100 parts by weight of styrene-acryl copolymer, 3 parts by weight of copper phthalocyanine as a coloring agent, 2.5 parts by weight of charge control agent (Bontron E-81 commercially available from Orient Chemical Industry Co.,Ltd.), and 2 parts by weight of polyethylene wax as a lubricant (Neowax E-3 commercially available from Yasuhara Chemical Co.,Ltd.), which were blended together by means of Henschel mixer operated at 2500 rpm for 5 minutes. The blend was kneaded by a twin-screw extruder/kneader and then was formed into a sheet by a pressure roller. The resultant sheet was carried on a stainless-steel belt at 200° C. and then cooled.

Next, the sheet-like product was pulverized by Cryptron pulverizer (commercially available from Kawasaki Heavy Industries Ltd.) and classified by Elbow-jet available from Matsuzaka Trading Co.,Ltd., thereby giving toner particles.

There was prepared a mixture containing 100 parts by weight of toner particles so obtained, 0.5 parts by weight of hydrophobic titanium (STT-30A commercially available from Titan Kogyo) and 0.25 parts by weight of hydrophobic silica (H-2000 commercially available from Wacker Chemical Inc.), which were blended together by Henshcel mixer operated at 2500 rpm for 120 seconds. Thus was obtained Toner t1 having a volume average particle size of 9.3 μm.

(Toner t2)

Toner t2 having a volume average particle size of 8.9 μm was prepared the same way as in the preparation of Toner t1, except that the blend kneaded by the twin-screw extruder/kneader was formed into a sheet by the pressure roller and then was cooled. The sheet was not committed to the stainless-steel belt at 200° C.

(Toner t3)

Toner t3 was prepared as follows. A reaction vessel equipped with a reflux condenser, water separator, nitrogen gas inlet and thermometer was charged with 1100 parts by weight of bisphenol-A ethylene oxide adduct, 50 parts by weight of ethylene glycol, and 1300 parts by weight of isophthalic acid. The vessel was installed in a mantle heater. The mixture in the vessel was stirred with nitrogen gas introduced into the vessel so as to be subjected to dehydration polycondensation reaction at 230° C. When the acid number reached 43 KOHmg/g, the reaction vessel was evacuated to 6 mmHg and the reaction was allowed to continue for another one hour.

Subsequently, the reaction vessel was cooled to 150° C. under normal temperatures. Then, 3000 parts by weight of solvent mixture containing xylene and methanol in a ratio of 30:70 was added and stirred for 30 minutes. The mixture was further added with 1000 parts by weight of methanol and cooled for precipitation of polyester resin.

The polyester resin was collected and vacuum dried to give polyester resin to be used as the binder resin. The polyester resin had an acid number of 46 KOHmg/g, a number average molecular weight Mn of 4300, a glass transition point Tg of 63.2° C., and a softening point Tm of 112° C.

There was prepared a mixture of 100 parts by weight of polyester resin, 4 parts by weight of quinacridone pigment as a coloring agent, 2.5 parts by weight of charge control agent (Bontron E-81 commercially available from Orient Chemical Industry Co.,Ltd.), and 3 parts by weight of jojoba oil as a lubricant (Hydrogenated Jojoba-Oil Wax M-1 commercially available from Mitsuba Trading Co.,Ltd.), which were blended together by means of Henschel mixer operated at 2500 rpm for 5 minutes. The blend was kneaded by the twin-screw extruder/kneader and then was formed into a sheet by the pressure roller. The resultant sheet was cooled but not committed to the stainless-steel belt at 200° C.

Next, the sheet-like product was pulverized by Cryptron pulverizer (commercially available from Kawasaki Heavy Industries Ltd.) and classified by Elbow-jet available from Matsuzaka Trading Co.,Ltd., thereby giving toner particles.

There was prepared a mixture containing 100 parts by weight of toner particles so obtained, 0.5 parts by weight of hydrophobic titanium (STT-30A commercially available from Titan Kogyo) and 0.25 parts by weight of hydrophobic silica (H-2000 commercially available from Wacker Chemical Inc.), which were blended together by Henshcel mixer operated at 2500 rpm for 120 seconds. Thus was obtained Toner t3 having a volume average particle size of 7.3 μm.

(Toner t4)

Toner t4 was prepared as follows. The reaction vessel equipped with the reflux condenser, water separator, nitrogen gas inlet and thermometer was charged with 1700 parts by weight of bisphenol-A propylene oxide adduct, 1100 parts by weight of isophthalic acid, and 80 parts by weight of diethylene glycol. The vessel was installed in the mantle heater. The mixture in the vessel was stirred with nitrogen gas introduced into the vessel thereby to be subjected to dehydration polycondensation reaction at 240° C. The reaction provided a polyester resin P1.

In addition, the reaction vessel equipped with the reflux condenser, water separator, nitrogen gas inlet and thermometer was charged with 1760 parts by weight of bisphenol-A propylene oxide adduct, 1130 parts by weight of isophthalic acid, 350 parts by weight of 1,6-dipropyl-1,6-hexanediol and 75 parts by weight of glycerin. The same procedure as in the preparation of the above polyester resin P1 was taken to obtain a polyester resin P2.

Next, 80 parts by weight of polyester resin P1 and 20 parts by weight of polyester resin P2 were dissolved in 700 parts by weight of xylene. The resultant solution mixture was placed in the reaction vessel equipped with the reflux condenser, mechanical stirrer and thermometer, to which 35 parts by weight of diphenylmethane-4,4-diisocyanate was added for 1-hour reaction at 120° C.

After confirming that a liberated isocyante group had been substantially depleted, xylene was removed to a point that a proportion of the resin component was 50%. Subsequently, xylene was further removed by means of a dryer (EXEVA commercially available from Shinko Pantec Co.,Ltd.) which was operated at 190° C. for 5 minutes. Then, the resin was vacuum dried to give urethane-modified polyester to be used as the binder resin.

The urethane-modified polyester resin had a number average molecular weight Mn of 6500, a glass transition point Tg of 63.5° C., and a softening point Tm of 135° C.

There was prepared a mixture of 100 parts by weight of urethane-modified polyester, 8 parts by weight of carbon black as a coloring agent (MA-100 commercially available from Mitsubishi Kagaku Corporation), 2.5 parts by weight of low-molecular-weight polypropylene as a lubricant (Biscol TS-200 commercially available from Sanyo Chemical Industries Ltd.) and 3 parts by weight of charge control agent (Eisen Spiron Black T-77 commercially available from Hodogaya Chemical Co.,Ltd) which were blended together by Henschel mixer operated at 2500 rpm for 5 minutes. The blend was kneaded by the twin-screw extruder/kneader and then was formed into a sheet by the pressure roller. The resultant sheet was carried on the stainless-steel belt at 200° C. and then cooled.

Next, the sheet-like product was pulverized by Cryptron pulverizer (commercially available from Kawasaki Heavy Industries Ltd.) and classified by Elbow-jet from Matsuzaka Trading Co.,Ltd., thereby giving toner particles.

There was prepared a mixture containing 100 parts by weight of toner particles so obtained, 0.5 parts by weight of hydrophobic titanium (STT-30A commercially available from Titan Kogyo) and 0.25 parts by weight of hydrophobic silica (H-2000 commercially available from Wacker Chemical Inc.), which were blended together by Henshcel mixer operated at 2500 rpm for 120 seconds. Thus was obtained Toner t4 having a volume-average particle size of 9.5 μm.

(Toner t5)

Toner t5 was prepared as follows. The reaction vessel equipped with the reflux condenser, mechanical stirrer and thermometer was charged with 200 parts by weight of toluene, 85 parts by weight of styrene monomer, 10 parts by weight of n-butyl acrylate monomer, 5 parts by weight of methacrylic acid, and 2 parts by weight of azo-isobutyronitrile as a polymerization initiator. The mixture was reacted at 60° C. for 4 hours, and then at 80° C. for 2 hours. Subsequently, styrene-acryl copolymer was obtained by removing the solvent of toluene in vacuo.

The styrene-acryl copolymer had a glass transition point Tg of 60° C., a number average molecular weight Mn of 5700, and a softening point Tm of 126° C.

There was prepared a mixture of 100 parts by weight of styrene-acryl copolymer, 3 parts by weight of copper phthalocyanine as a coloring agent, 2 parts by weight of charge control agent (Bontron E-81 commercially available from Orient Chemical Industry Co.,Ltd.), and 2.5 parts by weight of lubricant (PARAFLINTC-105 commercially available from katoh Yoko Co.,Ltd.), which were blended together by means of Henschel mixer operated at 2500 rpm for 5 minutes. The blend was kneaded by the twin-screw extruder/kneader and then was formed into a sheet by the pressure roller. The resultant sheet was cooled but not committed to the stainless-steel belt at 200° C.

Next, the sheet-like product was pulverized by a supersonic jet pulverizer (PJM 1-5 commercially available from Nippon Pneumatic Mfg. Co.,Ltd.) and classified by Elbow-jet (commercially available from Matsuzaka Trading Co.,Ltd.), thereby giving toner particles.

There was prepared a mixture containing 100 parts by weight of toner particles so obtained, 0.5 parts by weight of hydrophobic titanium (STT-30A commercially available from Titan Kogyo) and 0.25 parts by weight of hydrophobic silica (H-2000 commercially available from Wacker Chemical Inc.), which were blended together by Henshcel mixer operated at 2500 rpm for 120 seconds. Thus was obtained Toner t5 having a volume average particle size of 8.6 μm.

(Toner t6)

Toner t6 was prepared as follows. The reaction vessel equipped with the reflux condenser, water separator, nitrogen gas inlet and thermometer was charged with 90 parts by weight of styrene monomer, 10 parts by weight of n-butyl acrylate monomer, 0.5 parts by weight of divinylbenzene, and 1 part by weight of benzoyl peroxide as a polymerization initiator. Then, 300 parts by weight of ion-exchange water with 0.1 part by weight of saponified product of polyvinyl alcohol component dissolved therein was added to the reaction vessel. After a step of evacuating the vessel followed by nitrogen backfill, the mixture in the vessel was suspended by stirring thereby to. be subjected to suspension polymerization at 60 to 70° C. for 6 hours. The suspension was filtered to give styrene-acryl copolymer particles, which were dewatered and dried.

The styrene-acryl copolymer had a number average molecular weight Mn of 7300, a glass transition point Tg of 59° C., and a softening point Tm of 135° C.

There was prepared a mixture of 100 parts by weight of styrene-acryl copolymer so obtained, 3 parts by weight of copper phthalocyanine as a coloring agent, 2.5 parts by weight of charge control agent (Bontron E-81 commercially available from Orient Industry Co.,Ltd.) and 2 parts by weight of lubricant (Carnauba wax commercially available from Katoh Yoko Co.,Ltd) which were blended together by Henschel mixer operated at 2500 rpm for 5 minutes. The blend was kneaded by the twin-screw extruder/kneader and then was formed into a sheet by the pressure roller. The resultant sheet was carried on the stainless-steel belt at 200° C. and then cooled.

Next, the sheet-like product was pulverized by Cryptron pulverizer (commercially available from Kawasaki Heavy Industries Ltd.) and classified by Elbow-jet available from Matsuzaka Trading Co.,Ltd., thereby giving toner particles.

There was prepared a mixture containing 100 parts by weight of toner particles so obtained, 0.5 parts by weight of hydrophobic titanium (STT-30A commercially available from Titan Kogyo) and 0.25 parts by weight of hydrophobic silica (H-2000 commercially available from Wacker Chemical Inc.), which were blended together by Henshcel mixer operated at 2500 rpm for 120 seconds. Thus was obtained Toner t6 having a volume average particle size of 9.3 μm.

Each of Toners t1 to t6 thus prepared was subjected to a gas chromatography (Headspace Gas-Chromatography GC-9A commercially available from Shimadzu Corporation) for determining the amount of benzene, toluene, ethylbenzene, o-xylene, m-xylene or p-xylene, the amount of styrene monomer as the vinyl monomer, and the combined amount Q of the above organic aromatic solvent and styrene monomer, which were contained in each of Toners t1 to t6. The results are listed in Table 1 as below.

TABLE 1

| | type of toner, content of solvent and monomer | | | | | |
|---|---|---|---|---|---|---|
| | t1 | t2 | t3 | t4 | t5 | t6 |
| benzene | — | — | — | — | — | — |
| toluene | 25 | 370 | — | — | 420 | — |
| o-xylene | — | — | 20 | 10 | — | — |
| m-xylene | — | — | 80 | 50 | — | — |
| p-xylene | — | — | 120 | 88 | — | — |
| ethyl- | 4 | 35 | — | — | 86 | 170 |
| benzene | | | | | | |
| stylene | 15 | 60 | — | — | 110 | 360 |
| monomer | | | | | | |
| total | 44 | 465 | 220 | 148 | 616 | 530 |
| amount Q | | | | | | |

According to the results, Toners t1 to t4 each contained the organic aromatic solvent and styrene monomer in combined concentrations of not more than 500 ppm whereas Toners t5, t6 each contained the organic aromatic solvent and styrene monomer in combined concentrations of more than 500 ppm.

(Experiment 1)

This experiment used the following 6 types of charger members A1 to A6 as examples of the foregoing charger member 20.

(Charger Member A1)

A charger member A1 comprised a metallic roller and a surface layer including a 3-mm thick elastic layer laid over an outer periphery of the roller and formed from urethane foam added with carbon black as an electroconductive material, and a 15-μm thick coat layer of urethane laid over the elastic layer. The member had a volume electrical resistance of 7×10⁵ Ω.cm and a rubber hardness of 78 degrees.

(Charger Member A2)

A charger member A2 comprised a 2-mm thick sheet formed from silicone rubber added with carbon black as the electroconductive material. The member had a volume electrical resistance of 8×10⁴ Ω.cm and a rubber hardness of 73 degrees.

(Charger Member A3)

A charger member A3 comprised a 2-mm thick sheet formed from styrene-butadiene copolymer added with carbon black as the electroconductive material. The member had a volume electrical resistance of 5×10⁸ Ω.cm and a rubber hardness of 68 degrees.

(Charger Member A4)

A charger member A4 comprised a metallic roller, and a surface layer consisting of a 3-mm thick elastic layer laid over an outer periphery of the metallic roller and formed from silicone rubber added with carbon black as the electroconductive material. The member had a volume electrical resistance of 5×10⁵ Ω.cm and a rubber hardness of 32 degrees.

(Charger Member A5)

A charger member A5 comprised a 2-mm thick sheet formed from styrene-butadiene copolymer added with carbon black as the electroconductive material and powdery silica as a filling agent. The member had a volume electrical resistance of 5×10⁶ Ω.cm and a rubber hardness of 95 degrees.

(Charger Member A6)

A charger member A6 comprised a metallic roller, and a surface layer consisting of a 3-mm thick elastic layer laid over an outer periphery of the metallic roller and formed from styrene-butadiene copolymer added with carbon black as the electroconductive material and powdery silica as the filling agent. The member had a volume electrical resistance of 5×10³ Ω.cm and a rubber hardness of 76 degrees.

### EXAMPLES 1-1 to 1-4 AND COMPARATIVE EXAMPLES 1-1 to 1-6

In Examples 1-1 to 1-4 and Comparative Examples 1-1 to 1-6, the above toners and charger members were used in combinations as shown in the following Table 2A and Table 2B.

Examples 1-1 to 1-3 and Comparative Examples 1-1, 1-2, 1-4 and 1-5 used a printer (Page Pro PS commercially available from Minolta Co.,Ltd.) with its charging device modified, respectively, whereas Example 1-4 and Comparative Examples 1-3 and 1-6 used a printer (LP-1700 commercially available from EPSON Corporation) with its charging device modified, respectively. Each of the printers was continuously operated for 2 hours and then stored at 50° C. for 1000 hours. Subsequently, each printer was subjected to a durability test of continuous production of 50000 prints and the produced images were evaluated for fogging, image density, density variations, non-uniform density of half-tone area, streaking, and dot reproducibility. The results are listed in Table 2A and Table 2B as below.

In the evaluation of the fogging, image density, density variations, non-uniform density of half-tone area, streaking and dot reproducibility, a symbol ◯ denotes an excellent level, Δ denotes a practically acceptable level, and X denotes a practically unacceptable level.

TABLE 2A

example

| | 1-1 | 1-2 | 1-3 | 1-4 |
|---|---|---|---|---|
| toner | t1 | t2 | t3 | t4 |
| Q (ppm) | 44 | 465 | 220 | 148 |
| charger member | A1 | A2 | A3 | A1 |
| rubber hardness | 78 | 73 | 68 | 78 |
| | degrees | degrees | degrees | degrees |
| volume electrical | 7 × 10⁵ | 8 × 10⁴ | 5 × 10⁸ | 7 × 10⁵ |
| resistance (Ω · cm) | | | | |
| fogging | ◯ | ◯ | ◯ | ◯ |
| image density | ◯ | Δ | ◯ | ◯ |
| density variations | ◯ | Δ | ◯ | ◯ |
| non-uniform density | ◯ | Δ | ◯ | ◯ |
| of half-tone area | | | | |
| streaking | ◯ | ◯ | ◯ | ◯ |
| dot reproducibility | ◯ | ◯ | ◯ | ◯ |

TABLE 2B

| | comparative example | | | | | |
|---|---|---|---|---|---|---|
| | 1-1 | 1-2 | 1-3 | 1-4 | 1-5 | 1-6 |
| toner | t5 | t6 | t1 | t1 | t2 | t6 |
| Q (ppm) | 616 | 530 | 44 | 44 | 465 | 530 |
| charger | A1 | A1 | A5 | A4 | A6 | A4 |
| member | | | | | | |
| rubber | 78 | 78 | 95 | 32 | 76 | 32 |
| hardness | degrees | degrees | degrees | degrees | degrees | degrees |
| volume | 7 × 10⁵ | 7 × 10⁵ | 5 × 10⁶ | 5 × 10⁵ | 5 × 10³ | 5 × 10⁵ |
| electrical | | | | | | |
| resistance | | | | | | |
| (Ω · cm) | | | | | | |
| fogging | Δ | Δ | Δ | Δ | Δ | X |
| image density | X | Δ | X | X | X | X |
| density | X | X | X | X | X | X |
| variations | | | | | | |
| non-uniform | X | X | X | X | X | X |
| density | | | | | | |
| of half-tone | | | | | | |
| area | | | | | | |
| streaking | Δ | Δ | Δ | X | X | X |
| dot | ◯ | Δ | Δ | Δ | Δ | X |
| reproducibility | | | | | | |

(Experiment 2)

This experiment used the following 5 types of developer carrying members B1 to B5 as examples of the foregoing developer carrying member 11.

(Developer Carrying Member B1)

A developer carrying member B1 comprised a metallic roller and a surface layer laid over an outer periphery of the metallic roller and including a 1-mm thick elastic layer formed from silicone rubber added with an electroconductive material of carbon black, a 15-μm thick intermediate layer formed from the electroconductive material of carbon black, and a 20-μm thick coat layer formed from urethane added with the electroconductive material of carbon black. The member had a volume electrical resistance of 6×10⁵ Ω.cm, a rubber hardness of 53 degrees, and an elongation of 480%.

(Developer Carrying Member B2)

A developer carrying member B2 comprised a metallic roller, and a surface layer laid over an outer periphery of the metallic roller and consisting of a 1-mm thick elastic layer formed from styrene-butadiene copolymer added with the electroconductive material of carbon black. The member had a volume electrical resistance of 7×10⁴ Ω.cm, a rubber hardness of 58 degrees, and an elongation of 660%.

(Developer Carrying Member B3)

A developer carrying member B3 comprised a metallic roller, and a surface layer laid over an outer periphery of the metallic roller and including a 1-mm thick elastic layer formed from styrene-butadiene copolymer added with the electroconductive material of carbon black, and a 20-μm thick coat layer formed from urethane added with the electroconductive material of carbon black. The member had a volume electrical resistance of 4×10⁵ Ω.cm, a rubber hardness of 42 degrees, and an elongation of 860%.

(Developer Carrying Member B4)

A developer carrying member B4 comprised a metallic roller, and a surface layer laid over an outer periphery of the metallic roller and consisting of a 1-mm thick elastic layer formed from styrene-butadiene copolymer. The member had a volume electrical resistance of 7×10³ Ω.cm, a rubber hardness of 16 degrees, and an elongation of 900%.

(Developer Carrying Member B5)

A developer carrying member B5 comprised a metallic roller, and a surface layer laid over an outer periphery of the metallic roller and consisting of a 1-mm thick elastic layer formed from silicone rubber added with the electroconductive material of carbon black. The member had a volume electrical resistance of 3×10⁸ Ω.cm, a rubber hardness of 86 degrees, and an elongation of 181%.

### EXAMPLES 2-1 to 2-4 AND COMPARATIVE EXAMPLES 2-1 to 2-6

In Examples 2-1 to 2-4 and Comparative Examples 2-1 to 2-6, the above toners and developer carrying members were used in combinations as shown in the following Table 3A and Table 3B.

Examples 2-1 to 2-3 and Comparative Examples 2-1 to 2-4 and 2-6 used a printer (Page Pro PS commercially available from Minolta Co.,Ltd.) with its developing device modified, respectively, whereas Example 2-4 and Comparative Example 2-5 used a printer (LP-9200 commercially available from EPSON Corporation) with its developing device modified, respectively. Each of the printers was continuously operated for 2 hours and then stored at 50° C. for 1000 hours. Subsequently, each printer was subjected to the durability test of continuous production of 50000 prints and the produced images were evaluated for fogging, image density, density variations, non-uniform density of half-tone area, streaking, and dot reproducibility. The results are listed in Table 3A and Table 3B as below.

In the evaluation of the fogging, image density, density variations, non-uniform density of half-tone area, streaking and dot reproducibility, the symbol ◯ denotes an excellent level, Δ denotes a practically acceptable level, and X denotes a practically unacceptable level.

TABLE 3A

example

| | 2-1 | 2-2 | 2-3 | 2-4 |
|---|---|---|---|---|
| toner | t1 | t2 | t3 | t4 |
| Q (ppm) | 44 | 465 | 220 | 148 |
| developer carrying | B1 | B2 | B3 | B1 |
| member | | | | |
| rubber hardness | 53 | 58 | 42 | 53 |
| | degrees | degrees | degrees | degrees |
| elongation (%) | 480 | 660 | 860 | 480 |
| volume electrical | 6 × 10⁵ | 7 × 10⁴ | 4 × 10⁵ | 6 × 10⁵ |
| resistance (Ω · cm) | | | | |
| fogging | ◯ | ◯ | Δ | ◯ |
| image density | ◯ | Δ | Δ | ◯ |
| density variations | ◯ | Δ | Δ | ◯ |
| non-uniform density | ◯ | Δ | ◯ | ◯ |
| of half-tone area | | | | |
| streaking | ◯ | ◯ | ◯ | ◯ |
| dot reproducibility | ◯ | ◯ | ◯ | ◯ |

TABLE 3B

| | comparative example | | | | | |
|---|---|---|---|---|---|---|
| | 2-1 | 2-2 | 2-3 | 2-4 | 2-5 | 2-6 |
| toner | t5 | t6 | t2 | t2 | t1 | t5 |
| Q (ppm) | 616 | 530 | 465 | 465 | 44 | 616 |
| developer | B2 | B1 | B5 | B4 | B5 | B3 |
| carrying | | | | | | |
| memter | | | | | | |
| rubber | 58 | 53 | 86 | 16 | 86 | 42 |
| hardness | degrees | degrees | degrees | degrees | degrees | degrees |
| elongation | 660 | 480 | 181 | 900 | 181 | 860 |
| (%) | | | | | | |
| volume | 7 × 10⁴ | 6 × 10⁵ | 3 × 10⁸ | 7 × 10¹³ | 3 × 10⁸ | 4 × 10⁵ |
| electrical | | | | | | |
| resistance | | | | | | |
| (Ω · cm) | | | | | | |
| fogging | Δ | Δ | Δ | X | ◯ | X |
| image | Δ | Δ | Δ | Δ | Δ | X |
| density | | | | | | |
| density | X | X | X | X | Δ | X |
| variations | | | | | | |
| non-uniform | X | X | X | X | X | X |
| density of | | | | | | |
| half-tone | | | | | | |
| area | | | | | | |
| streaking | X | Δ | X | X | X | X |
| dot | Δ | ◯ | Δ | Δ | Δ | X |
| re- | | | | | | |
| producibility | | | | | | |

(Experiment 3)

This experiment used the following 5 types of regulating members C1 to C5 as examples of the foregoing regulating member 14.

(Regulating Member C1)

A regulating member C1 comprised a 2-mm thick sheet base formed from silicone rubber added with the electroconductive material of carbon black, and a 20-μm thick coat layer laid over a surface of the base sheet and formed from urethane added with the electroconductive material of carbon black. The member had a volume electrical resistance of 6×10Ω.cm, a rubber hardness of 53 degrees, and an elongation of 570%.

(Regulating Member C2)

A regulating member C2 comprised a 2-mm thick base sheet formed from styrene-butadiene copolymer added with the electroconductive material of carbon black. The member had a volume electrical resistance of 7×10⁴ Ω.cm, a rubber hardness of 48 degrees, and an elongation of 550%.

(Regulating Member C3)

A regulating member C3 comprised a 2-mm thick base sheet formed from silicone rubber added with the electroconductive material of carbon black. The member had a volume electrical resistance of 3×10⁸ Ω.cm, a rubber hardness of 87 degrees, and an elongation of 175%.

(Regulating Member C4)

A regulating member C4 comprised a 2-mm thick base sheet formed from styrene-butadiene copolymer. The member had a volume electrical resistance of 7×10³ Ω.cm, a rubber hardness of 17 degrees, and an elongation of 890%.

(Regulating Member C5)

A regulating member C5 comprised a 2-mm thick base sheet formed from styrene-butadiene copolymer added with the electroconductive material of carbon black, and a 20-μm thick coat layer laid over a surface of the base sheet and formed from urethane added with the electroconductive material of carbon black. The member had a volume electrical resistance of 4×10⁵ Ω.cm, a rubber hardness of 43 degrees, and an elongation of 850%.

### EXAMPLES 3-1 to 3-4 AND COMPARATIVE EXAMPLES 3-1 to 3-6

In Examples 3-1 to 3-4 and Comparative Examples 3-1 to 3-6, the above toners and regulating members were used in combinations as shown in the following Table 4A and Table 4B.

Examples 3-1 to 3-3 and Comparative Examples 3-1 to 3-4 used a printer (Page Pro PS commercially available from Minolta Co.,Ltd.) with its developing device modified, respectively, whereas Example 3-4 and Comparative Examples 3-5 and 3-6 used a printer (LP-9200 commercially available from EPSON Corporation) with its developing device modified, respectively. Each of the printers was continuously operated for 2 hours and then stored at 50° C. for 1000 hours. Subsequently, each printer was subjected to the durability test of continuous production of 50000 prints and the produced images were evaluated for fogging, image density, density variations, non-uniform density of half-tone area, streaking, and dot reproducibility. The results are listed in Table 4A and Table 4B as below.

In the evaluation of the fogging, image density, density variations, non-uniform density of half-tone area, streaking and dot reproducibility, the symbol ◯ denotes an excellent level, Δ denotes a practically acceptable level, and X denotes a practically unacceptable level.

TABLE 4A

| | example | | | |
|---|---|---|---|---|
| | 3-1 | 3-2 | 3-3 | 3-4 |
| toner | t1 | t2 | t3 | t4 |
| Q (ppm) | 44 | 465 | 220 | 148 |
| regulating member | C1 | C2 | C1 | C1 |
| rubber hardness | 53 | 48 | 53 | 53 |
| | degrees | degrees | degrees | degrees |
| elongation (%) | 570 | 550 | 570 | 570 |
| volume electrical | 6 × 10⁵ | 7 × 10⁴ | 6 × 10⁵ | 6 × 10⁵ |
| resistance (Ω · cm) | | | | |
| fogging | ◯ | ◯ | ◯ | ◯ |
| image density | ◯ | ◯ | ◯ | ◯ |
| density variations | ◯ | Δ | ◯ | ◯ |
| non-uniform density | ◯ | Δ | ◯ | ◯ |
| of half-tone area | | | | |
| streaking | ◯ | Δ | ◯ | ◯ |
| dot reproducibility | ◯ | ◯ | ◯ | ◯ |

TABLE 4B

| | comparative example | | | | | |
|---|---|---|---|---|---|---|
| | 3-1 | 3-2 | 3-3 | 3-4 | 3-5 | 3-6 |
| toner | t5 | t6 | t1 | t1 | t1 | t5 |
| Q (ppm) | 616 | 530 | 44 | 44 | 44 | 616 |
| regulating | C2 | C2 | C3 | C4 | C5 | C5 |
| member | | | | | | |
| rubber | 48 | 48 | 87 | 17 | 43 | 43 |
| hardness | degrees | degrees | degrees | degrees | degrees | degrees |
| elongation | 550 | 550 | 175 | 890 | 850 | 850 |
| (%) | | | | | | |
| volume | 7 × 10⁴ | 7 × 10⁴ | 3 × 10⁸ | 7 × 10¹³ | 4 × 10⁵ | 4 × 10⁵ |
| electrical | | | | | | |
| resistance | | | | | | |
| (Ω · cm) | | | | | | |
| fogging | X | Δ | Δ | X | Δ | X |
| image | X | Δ | Δ | Δ | Δ | X |
| density | | | | | | |
| density | X | X | Δ | X | X | X |
| variations | | | | | | |
| non-uniform | X | X | X | X | X | X |
| density | | | | | | |
| of half- | | | | | | |
| tone area | | | | | | |
| streaking | X | X | X | X | X | X |
| dot | Δ | Δ | Δ | Δ | X | X |
| re- | | | | | | |
| producibility | | | | | | |

(Experiment 4)

This experiment used the following 7 types of supply rollers D1 to D7 as examples of the foregoing supply roller 13.

(Supply Roller D1)

A supply roller D1 comprised a metallic roller, and a 3-mm thick elastic-foam layer laid over a surface of the metallic roller and formed from urethane foam added with the electroconductive material of carbon black. The roller had a volume electrical resistance of 7×10⁵ Ω.cm, an Asca F hardness of 50 degrees, and a cell count of 7.2 cells/mm.

(Supply Roller D2)

A supply roller D2 comprised a metallic roller, and a 4-mm thick elastic-foam layer laid over a surface of the metallic roller and formed from urethane foam added with the electroconductive material of carbon black. The roller had a volume electrical resistance of 8×10⁴ Ω.cm, an Asca F hardness of 43 degrees, and a cell count of 3.2 cells/mm.

(Supply Roller D3)

A supply roller D3 comprised a metallic roller, and a 4-mm thick elastic-foam layer laid over a surface of the metallic roller and formed from urethane foam added with the electroconductive material of carbon black. The roller had a volume electrical resistance of 6×10⁵ Ω.cm, an Asca F hardness of 64 degrees, and a cell count of 15.8 cells/mm.

(Supply Roller D4)

A supply roller D4 comprised a metallic roller, and a 3-mm thick elastic-foam layer laid over a surface of the metallic roller and formed from urethane foam added with the electroconductive material of carbon black. The roller had a volume electrical resistance of 4×10⁵ Ω.cm, an Asca F hardness of 41 degrees, and a cell count of 1.2 cells/mm.

(Supply Roller D5)

A supply roller D5 comprised a metallic roller, and a 3-mm thick elastic-foam layer laid over a surface of the metallic roller and formed from urethane foam added with the electroconductive material of carbon black. The roller had a volume electrical resistance of 5×10⁵ Ω.cm, an Asca F hardness of 23 degrees, and a cell count of 4.2 cells/mm.

(Supply Roller D6)

A supply roller D6 comprised a metallic roller, and a 3-mm thick elastic-foam layer laid over a surface of the metallic roller and formed from urethane foam added with the electroconductive material of carbon black. The roller had a volume electrical resistance of 3×10⁵ Ω.cm, an Asca F hardness of 85 degrees, and a cell count of 5.2 cells/mm.

(Supply Roller D7)

A supply roller D7 comprised a metallic roller, and a 3-mm thick elastic-foam layer laid over a surface of the metallic roller and formed from urethane foam added with the electroconductive material of carbon black. The roller had a volume electrical resistance of 7×10⁸ Ω.cm, an Asca F hardness of 68 degrees, and a cell count of 6.9 cells/mm.

### EXAMPLES 4-1 to 4-4 AND COMPARATIVE EXAMPLES 4-1 to 4-7

In Examples 4-1 to 4-4 and Comparative Examples 4-1 to 4-7, the above toners and supply rollers were used in combinations as shown in the following Table 5A and Table 5B.

Examples 4-1 to 4-3 and Comparative Examples 4-1 to 4-3 and 4-5 used a printer (Page Pro PS commercially available from Minolta Co.,Ltd.) with its developing device modified, respectively, whereas Example 4-4 and Comparative Examples 4-4, 4-6 and 4-7 used a printer (LP-9200 commercially available from EPSON Corporation) with its developing device modified, respectively. Each of the printers was continuously operated for 2 hours and then stored at 50° C. for 1000 hours. Subsequently, each printer was subjected to the durability test of continuous production of 50000 prints and the produced images were evaluated for fogging, image density, density variations, non-uniform density of half-tone area, streaking, and dot reproducibility. The results are listed in Table 5A and Table 5B as below.

In the evaluation of the fogging, image density, density variations, non-uniform density of half-tone area, streaking and dot reproducibility, the symbol ◯ denotes an excellent level, Δ denotes a practically acceptable level and X denotes a practically unacceptable level.

TABLE 5A

| | example | | | |
|---|---|---|---|---|
| | 4-1 | 4-2 | 4-3 | 4-4 |
| toner | t1 | t2 | t3 | t4 |
| Q (ppm) | 44 | 465 | 220 | 148 |
| supply roller | D1 | D2 | D1 | D7 |
| Asca F hardness | 50 | 43 | 50 | 68 |
| | degrees | degrees | degrees | degrees |
| cell count (cells/mm) | 7.2 | 3.2 | 7.2 | 6.9 |
| volume electrical | 7 × 10⁵ | 8 × 10⁴ | 7 × 10⁵ | 7 × 10⁸ |
| resistance (Ω · cm) | | | | |
| fogging | ◯ | ◯ | ◯ | ◯ |
| image density | ◯ | ◯ | ◯ | ◯ |
| density variations | ◯ | Δ | ◯ | ◯ |
| non-uniform density | ◯ | Δ | ◯ | ◯ |
| of half-tone area | | | | |
| streaking | ◯ | Δ | ◯ | ◯ |
| dot reproducibility | ◯ | ◯ | ◯ | ◯ |

TABLE 5B

| | comparative example | | | | | | |
|---|---|---|---|---|---|---|---|
| | 4-1 | 4-2 | 4-3 | 4-4 | 4-5 | 4-6 | 4-7 |
| toner | t4 | t4 | t1 | t4 | t5 | t6 | t5 |
| Q (ppm) | 148 | 148 | 44 | 148 | 616 | 530 | 616 |
| supply roller | D3 | D4 | D5 | D6 | D1 | D1 | D5 |
| Asca F hardness | 64 | 41 | 23 | 85 | 50 | 50 | 23 |
| | degrees | degrees | degrees | degrees | degrees | degrees | degrees |
| cell count | 15.8 | 1.2 | 4.2 | 5.0 | 7.2 | 7.2 | 4.2 |
| (cells/m) | | | | | | | |
| volume electrical | 6 × 10⁵ | 4 × 10⁵ | 5 × 10⁵ | 3 × 10⁵ | 7 × 10⁵ | 7 × 10⁵ | 5 × 10⁵ |
| resistance (Ω · cm) | | | | | | | |
| fogging | ◯ | ◯ | Δ | X | X | X | X |
| image density | Δ | X | X | X | Δ | Δ | X |
| density | X | X | X | Δ | X | X | X |
| variations | | | | | | | |
| non-uniform | X | Δ | Δ | X | X | X | X |
| density of | | | | | | | |
| half-tone area | | | | | | | |
| streaking | X | Δ | Δ | X | X | X | X |
| dot | Δ | ◯ | Δ | ◯ | Δ | Δ | X |
| reproducibility | | | | | | | |

Although the present invention has been fully described by way of examples, it is to be noted that various changes and modifications will become apparent to those skilled in the art.

Therefore, unless otherwise such changes and modifications depart from the scope of the invention, they should be construed as being included therein.

What is claimed is:

1. A developing device comprising:
a developer carrying member having a rubber hardness of 20 to 70 degrees, an elongation of 400 to 1200% and a volume electrical resistance of 1×10⁴ to 1×10⁹ Ω.cm at its surface;
a storage portion for storing a toner to be supplied to the developer carrying member, the toner containing an organic aromatic solvent and a vinyl monomer in combined concentrations of not more than 500 ppm; and
a regulating member disposed in contacting relation with the surface of the developer carrying member for regulating the amount of toner carried on the developer carrying member.

2. The developing device as claimed in claim 1, wherein the developer carrying member comprises a metallic roller and a surface layer laid over an outer periphery of the roller.

3. The developing device as claimed in claim 2, wherein the surface layer has a rubber hardness of 30 to 65 degrees, an elongation of 450 to 1000% and a volume electrical resistance of 5×10⁴ to 1×10⁸ Ω.cm.

4. The developing device as claimed in claim 1, wherein the toner contains the organic aromatic solvent and the vinyl monomer in combined concentrations of not more than 300 ppm.

5. The developing device as claimed in claim 1, wherein the toner contains the organic aromatic solvent and the vinyl monomer in combined concentrations of not more than 200 ppm.

6. A developing device comprising:
a developer carrying member for carrying a toner on its surface;
a storage portion for storing the toner to be supplied to the developer carrying member, the toner containing an organic aromatic solvent and a vinyl monomer in combined concentrations of not more than 500 ppm; and
a regulating member disposed in contacting relation with the surface of the developer carrying member for regulating the amount of toner carried on the developer carrying member, and having a rubber hardness of 20 to 70 degrees and an elongation of 100 to 800%.

7. The developing device as claimed in claim 6, wherein the regulating member has a rubber hardness of 30 to 65 degrees and an elongation of 200 to 700%.

8. The developing device as claimed in claim 6, wherein the regulating member has a volume electrical resistance of 1×10² to 1×10¹⁰ Ω.cm.

9. The developing device as claimed in claim 6, wherein the toner contains the organic aromatic solvent and the vinyl monomer in combined concentrations of not more than 300 ppm.

10. The developing device as claimed in claim 6, wherein the toner contains the organic aromatic solvent and the vinyl monomer in combined concentrations of not more than 200 ppm.

11. A developing device comprising:
a developer carrying member for carrying a toner on its surface;
a storage portion for storing the toner containing an organic aromatic solvent and a vinyl monomer in combined concentrations of not more than 500 ppm;
a supply roller for supplying the developer carrying member with the toner stored in the storage portion, the supply roller including an elastic-foam layer having an Asca F hardness of 30 to 80 degrees and a cell count of 2 to 10 cells/mm; and
a regulating member disposed in contacting relation with the surface of the developer carrying member for regulating the amount of toner carried on the developer carrying member.

12. The developing device as claimed in claim 11, wherein the supply roller comprises a metallic roller and an elastic-foam layer laid over an outer periphery of the roller.

13. The developing device as claimed in claim 12, wherein the elastic-foam layer has an Asca F hardness of 35 to 75 degrees and a cell count of 3 to 9 cells/mm.

14. The developing device as claimed in claim 11, wherein the elastic-foam layer has a volume electrical resistance of 1×10² to 1×10¹⁰ Ω.cm.

15. The developing device as claimed in claim 11, wherein the toner contains the organic aromatic solvent and the vinyl monomer in combined concentrations of not more than 300 ppm.

16. An image forming apparatus comprising:
an image bearing member;
a charger member disposed in contacting relation with the image bearing member, and having a rubber hardness of 40 to 90 degrees and a volume electrical resistance of 1×10⁴ to 1×10¹⁰ Ω.cm at its portion contacting the image bearing member;
a developing device including a developer carrying member for carrying a toner on its surface, a storage portion for storing the toner containing an organic aromatic solvent and a vinyl monomer in combined concentrations of not more than 500 ppm, and a regulating member disposed in contacting relation with the surface of the developer carrying member for regulating the amount of toner carried on the developer carrying member, the developing device operating to form a toner image on the image bearing member; and
a transfer member for transferring the toner image thus formed on the image bearing member onto a receiving medium.

17. The image forming apparatus as claimed in claim 16, wherein the charger member is a charger roller comprising a metallic roller and a surface layer laid over an outer periphery of the roller.

18. The image forming apparatus as claimed in claim 17, wherein the surface layer has a rubber hardness of 50 to 80 degrees and a volume electrical resistance of 1×10⁵ to 1×10⁹ Ω.cm.

19. The image forming apparatus as claimed in claim 16, wherein the toner contains the organic aromatic solvent and the vinyl monomer in combined concentrations of not more than 300 ppm.

20. The image forming apparatus as claimed in claim 16, wherein the transfer member is a transfer roller.
